(19) United States
(12) Patent Application Publication
(10) Pub. No.: US 2016/0349908 A1
(43) Pub. Date: Dec. 1, 2016

(54) OPERATION APPARATUS

(71) Applicant: AISIN SEIKI KABUSHIKI KAISHA, Kariya-shi (JP)

(72) Inventor: Takehiko SUGIURA, Kariya-shi (JP)

(73) Assignee: AISIN SEIKI KABUSHIKI KAISHA, Kariya-shi (JP)

(21) Appl. No.: 15/165,667

(22) Filed: May 26, 2016

(30) Foreign Application Priority Data
May 28, 2015 (JP) 2015-108646

(51) Int. Cl. G06F 3/041; E05B 81/64; E05B 81/56; G06F 3/044; E05B 81/04

(52) U.S. Cl. CPC G06F 3/0416; G06F 3/044; E05B 81/04; E05B 81/56; E05B 81/64

(57) ABSTRACT

An operation apparatus includes: a plurality of electrodes that configure different channels, respectively, and that output a detection signal having a level depending on a location of an operation body which is in contact or is not in contact therewith; and an operation detecting unit that detects an operation on a target object based on the detection signal from the plurality of electrodes, wherein the operation detecting unit includes an angled-point detecting section that detects an angled point of a unicursal character or symbol that is drawn by the operation body, based on that the detection signal is in a maintaining state of maintaining a constant level, and a discrimination section that discriminates a unicursal character or symbol that is drawn by the operation body, based on the detection result of the angled point by the angled-point detecting section.

### CROSS REFERENCE TO RELATED APPLICATIONS

This application is based on and claims priority under 35 U.S.C. §119 to Japanese Patent Application 2015-108646, filed on May 28, 2015, the entire contents of which are incorporated herein by reference.

### TECHNICAL FIELD

This disclosure relates to an operation apparatus that operates a target object.

### BACKGROUND DISCUSSION

In the related art, as an operation apparatus, for example, there has been known a vehicle equipment operation apparatus disclosed in JP 2014-61753 (Reference 1). The operation apparatus includes a main operation unit that is provided on a surface of a steering wheel of a vehicle and operates various devices (target objects). The main operation unit is a touchpad that has a dead zone inside and a plurality of electrodes that are arranged around the dead zone as a central point thereof. In this manner, an arcing input of drawing an arc around the dead zone, a horizontal sliding input of drawing a horizontal line, and a vertical sliding input of drawing a vertical line by a user's finger (operation body) can be distinguished.

Incidentally, the operation apparatus in Reference 1 performs only simple operations of the arcing input, the horizontal sliding input, and the vertical sliding input and, thus, a problem arises in that the number of types of settable operations is limited by definition. When so-called X-Y electrodes, in which multiple strips of electrodes are arranged in horizontal and vertical directions, are employed in order to increase the number of types of settable operations, another problem arises in that an electrical configuration becomes complicated.

### SUMMARY

Thus, a need exists for an operation apparatus which is not suspectable to the drawback mentioned above.

An operation apparatus according to an aspect of this disclosure includes: a plurality of electrodes that configure different channels, respectively, and that output a detection signal having a level depending on a location of an operation body which is in contact or is not in contact therewith; and an operation detecting unit that detects an operation on a target object based on the detection signal from the plurality of electrodes. The operation detecting unit includes an angled-point detecting section that detects an angled point of a unicursal character or symbol that is drawn by the operation body, based on that the detection signal is in a maintaining state of maintaining a constant level, and a discrimination section that discriminates a unicursal character or symbol that is drawn by the operation body, based on the detection result of the angled point by the angled-point detecting section.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a vehicle to which an embodiment of an operation apparatus is applied;

FIG. 2 is a front view illustrating a sensor body in the operation apparatus of the embodiment;

FIG. 3 is a block diagram illustrating an electrical configuration in the operation apparatus of the embodiment;

FIG. 4A is a view illustrating a state in which “C” is drawn in the vicinity of the sensor body, and FIGS. 4B to 4E are time charts illustrating changes in detection signals of 1 ch to 4 ch during the state in FIG. 4A;

FIG. 5A is a view illustrating a state in which “L” is drawn in the vicinity of the sensor body, and FIGS. 5B to 5E are time charts illustrating changes in detection signals of 1 ch to 4 ch during the state in FIG. 5A;

FIG. 6 is a flowchart illustrating a discrimination state or the like of a character or symbol in the operation apparatus of the embodiment;

FIG. 7 is a flowchart illustrating character or symbol recognizing processing in FIG. 6;

FIG. 8 is a list illustrating a relationship between a unicursal character or symbol and the number of angled points; and

FIGS. 9A to 9D illustrate a modification embodiment of the operation apparatus; FIG. 9A is a view of a sensor body having six radially-divided electrodes and depicting that “M” is drawn on the sensor body, FIG. 9B is a view of a sensor body having four radially-divided electrodes and depicting that “□” is drawn on the sensor body, and FIGS. 9C and 9D are views of a sensor body having three radially-divided electrodes and depicting that “Δ” and “ο” are drawn on the sensor body.

### DETAILED DESCRIPTION

Hereinafter, an embodiment of an operation apparatus will be described.

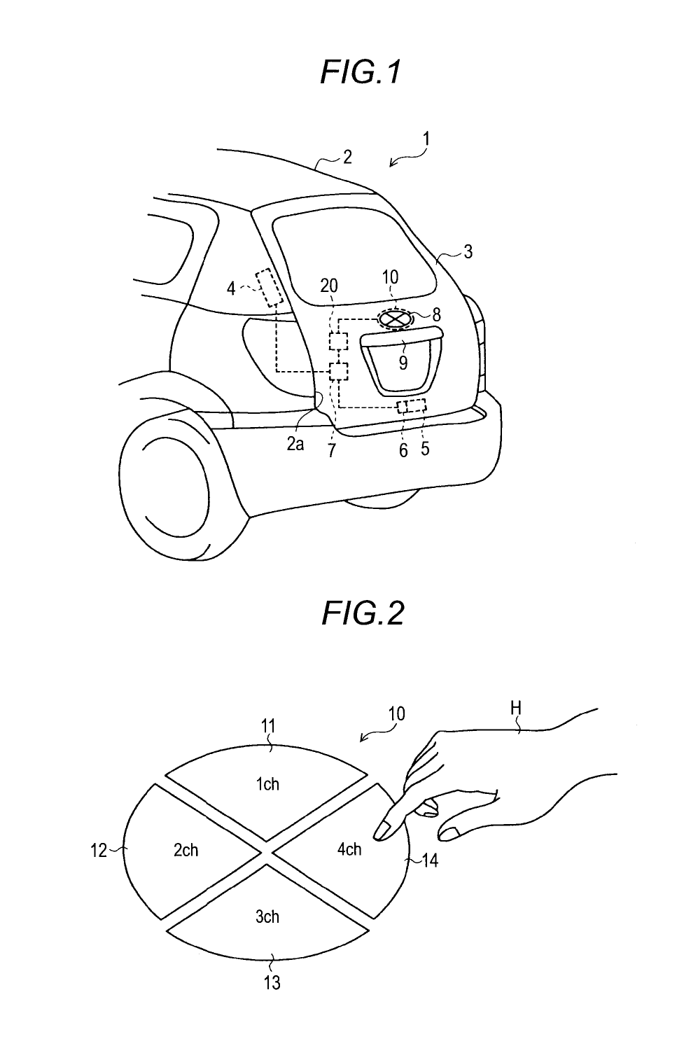

As illustrated in FIG. 1, an opening 2a is formed at a rear section of a body 2 of a vehicle 1 such as an automobile. In addition, at the rear section of the body 2, a back door 3 as a target object is attached in an openable and closable manner via a door hinge (not illustrated) provided in the upper portion of the opening 2a. The back door 3 is opened by being pushed upward around the hinge.

A door drive unit 4 is disposed at the rear section of the body 2. The door drive unit 4 is configured of, as a main member, an electrical drive source such as an electric motor, and is mechanically linked with the back door 3 via an appropriate door drive mechanism, thereby driving the back door 3 to be opened and closed. In addition, a door lock 5, as a target object, which locks and unlocks the back door 3 which is in a closed state, and a door lock drive unit 6 are disposed on a front end of the back door 3 on the inside of the vehicle interior. The door lock drive unit 6 is configured of, as a main member, an electrical drive source such as an electric motor, and is mechanically linked with the door lock 5 via an appropriate lock drive mechanism, thereby driving the door lock 5 so as to be locked and unlocked.

Both the door drive unit 4 and the door lock drive unit 6 are electrically connected to a door electronic control unit (ECU) 7 configured of a microcomputer (MCU), and are individually controlled to be driven by the door ECU 7.

A mark 8 such as a company name is disposed at the center (center above a garnish 9) on the outer surface of the back door 3, and a substantially elliptical sensor body 10 formed of, for example, a metal plate is disposed in a back portion of the mark 8. Since the sensor body 10, for example, detects a user's finger as an operation body that comes into contact with or approaches the mark 8, the sensor body is electrically connected to a control unit 20 as an operation detecting unit configured of, for example, the MCU. The control unit 20 is also electrically connected to the door ECU 7.

As illustrated in FIG. 2, the sensor body 10 has four radially divided electrodes 11, 12, 13, and 14. The electrodes 11 to 14, which are radially disposed from the vicinity of the center of the sensor body 10, configure 1 channel (ch) to 4 channel (ch) in order from the upper portion in a counterclockwise direction in FIG. 2. The electrodes 11 to 14 of the respective chs cause capacitance exhibited in cooperation with a user's finger H approaching the electrodes to change.

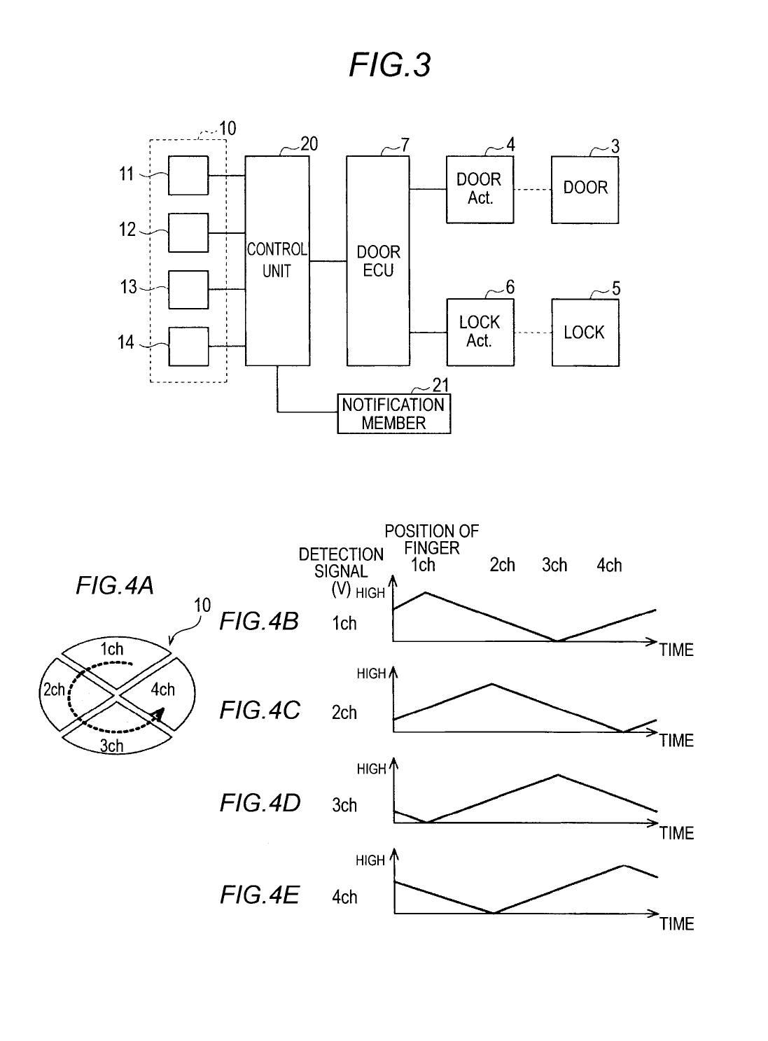

As illustrated in FIG. 3, the electrodes 11 to 14 are connected to the control unit 20. The control unit 20 outputs an oscillation signal to each of the electrodes 11 to 14, thereby causing the electrode to output a detection signal [V] having a voltage level depending on the capacitance. The control unit 20 inputs the detection signal, thereby detecting a user's finger H that approaches each of the electrodes 11 to 14. The output of the oscillation signal and the input of the detection signal corresponding to the output by the control unit 20 may be simultaneously performed with respect to all of the electrodes 11 to 14, or may be performed in order with respect to the electrodes 11 to 14 by being switched in a short time. Further, the control unit 20 is electrically connected to a notification member 21 such as an existing light-emitting apparatus (hazard flasher or the like) or an external light-emitting apparatus (LED or the like), or a vocal apparatus such as a speaker, and controls drive of the notification member 21.

Here, a user performs a smooth operation in a state in which the user's finger H comes into contact with or approaches the mark 8, that is, draws a preset unicursal character or symbol through a so-called swipe, and thereby an operation on a target object, which the user wants to achieve, is performed. In other words, a temporal change in the respective detection signals is made depending on a unicursal character or symbol that is drawn by the user. The control unit 20 discriminates the unicursal characters or symbols that is drawn by the user, based on the temporal change in the detection signal from all of the electrodes 11 to 14, that is, detects the operation on the back door 3 or the like, which the user wants to achieve.

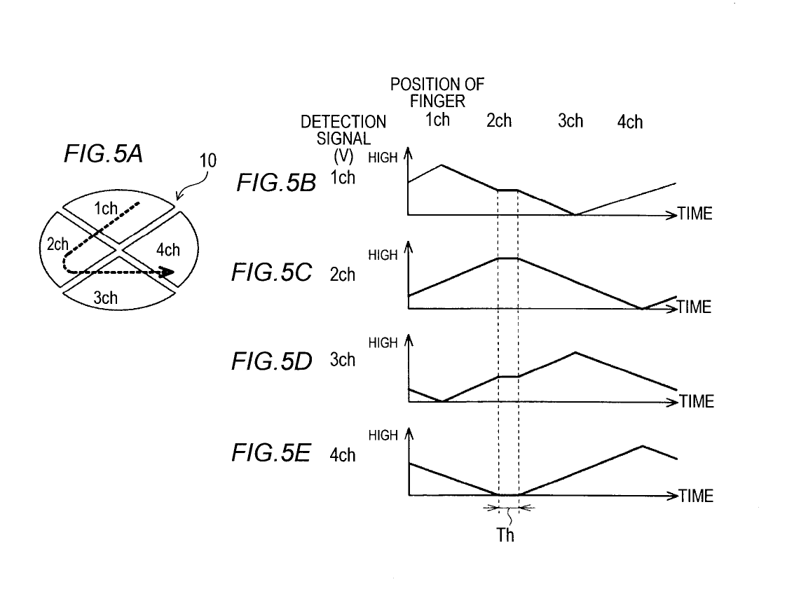

Next, as illustrated in FIGS. 4A and 5A, a discrimination method is described by drawing respective “C” and “L” in the vicinity of the sensor body 10, by the user's finger H. Further, the drawing of “C” and “L” corresponds to an operation of closing of the back door 3 and an operation of locking of the door lock 5, respectively. When drawing “C” and “L”, the user's finger H moves from 1 ch through 2 ch and 3 ch to 4 ch, in this order, for both of “C” and “L”. However, the number (times) of angled points at which the character or symbol is angled is “zero” in “C”, but “1” in “L”. The control unit 20 discriminates “C” and “L”, based on the detection results of the angled points.

As illustrated in FIGS. 4B to 4E, when the user's finger H moves to draw “C” from a position on 1 ch, which is closer to 4 ch, a detection signal from 1 ch (electrode 11) continues to increase until the finger H reaches the vicinity of the center of 1 ch. However, then, the detection signal decreases when the finger is separated from the center and passes the center. In addition, the detection signal from 2 ch (electrode 12) continues to increase until the user's finger H approaches and reaches 2 ch and then reaches the vicinity of the center thereof. However, then, the detection signal decreases when the finger is separated from the center and passes the center. Further, the detection signal from 3 ch (electrode 13) continues to increase until the user's finger H approaches and reaches 3 ch and then reaches the vicinity of the center thereof. However, then, the detection signal decreases when the finger is separated from the center and passes the center. In addition, the detection signal from 4 ch (electrode 14) continues to increase until the user's finger H approaches and reaches 4 ch and then reaches the vicinity of the center thereof. However, then, the detection signal decreases when the finger is separated from the center. In other words, crests (peaks) of the detection signals from 1 ch to 4 ch indicate timings of switching from a state in which the user's finger H approaches the centers of the electrodes 11 to 14 to a state in which the finger is separated from the centers, and troughs from the detection signals of 1 ch to 4 ch indicate timings of switching from the state in which the user's finger H is separated from the centers of the electrodes 11 to 14 to the state in which the finger approaches the centers. Hence, the detection signals from 1 ch to 4 ch are changed so as to have peaks in this order. In particular, the user's finger H that draws “C” smoothly moves without halting and thereby, the detection signals from 1 ch to 4 ch monotonously increase or decrease, respectively, before and after the peaks which are interposed therebetween. This is because the user's finger moves at a substantially constant speed, when the user's finger H draws a continuous curve (or straight line). Basically, the user's finger H is positioned at a position of the electrodes 11 to 14 having the detection signal with the highest level, of the detection signals from the 1 ch to 4 ch.

By comparison, as illustrated in FIGS. 5B to 5E, when the user's finger H moves to draw “L” from a position of 1 ch, which is closer to 4 ch, similarly, the detection signals from 1 ch to 4 ch are changed so as to have peaks in this order. Here, the user's finger H that draws “L” halts by reaching an angled point of “L” at a position of 2 ch. Therefore, all of the detection signals from 1 ch to 4 ch enter a maintaining state of maintaining a constant level, at a timing (timing that the level of the detection signal of 2 ch is the highest of 1 ch to 4 ch) when the user's finger H is positioned over 2 ch. In particular, the constant level maintained in the detection signal from 2 ch becomes the highest of 1 ch to 4 ch. Time Th taken during the maintaining state occurs due to the unconscious halting of the user's finger H at the angled point of “L”. However, in a case where halting at the angled point is instructed in advance as an operation method, the time Th taken during the maintaining state may occur due to the unconscious halting of the user's finger H at the angled point of “L”. In any case, the control unit 20 determines the time Th by being compared to a threshold, thereby detecting an angled point (angled-point detecting section).

The control unit 20 detects the angled point having such characteristics, thereby discriminating between “C” and “L” (discrimination section). Further, the control unit 20 discriminates “C”, thereby outputting, to the door ECU 7, an operation signal indicating that the back door 3 is caused to be closed, or the control unit discriminates “L”, thereby outputting, to the door ECU 7, an operation signal indicating that the door lock 5 is subjected to locking actuation. At this time, it is needless to say that the door ECU 7 controls the drive of the door drive unit 4 such that the back door 3 is subjected to close actuation, or controls the drive of the door lock drive unit 6 such that the door lock 5 is subjected to locking actuation.

Next, a discrimination state of “C” and “L”, or the like, by the control unit 20 will be collectively described. A process of the operation starts when the level of the detection signal from any of 1 ch to 4 ch (electrodes 11 to 14) exceeds a predetermined upper-limit threshold level Ls.

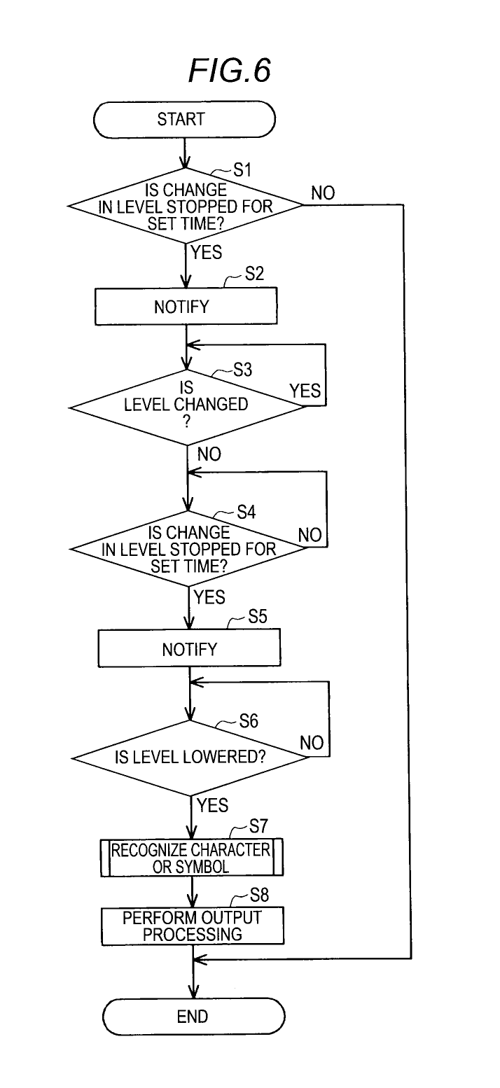

As illustrated in FIG. 6, when the process proceeds in this routine, in Step S1, the control unit 20 determines whether or not a state, in which the level of the corresponding detection signal exceeds the upper-limit threshold level Ls, is maintained for time Ts (for example, several seconds). The set time Ts is set to be sufficiently longer than the time (Th) taken during the maintaining state in which an angled point is detected.

Here, when it is determined that the state, in which the level of the corresponding detection signal does not exceed the upper-limit threshold level Ls, is not maintained for the set time Ts, the control unit 20 determines that the operation is not intended by the user (for example, erroneous detection due to an effect of inadvertent behavior of the user or a passerby, vehicle washing, rain, snow, or the like), and thus ends the process as is. By comparison, in Step S1, when it is determined that the state, in which the level of the corresponding detection signal exceeds the upper-limit threshold level Ls, is maintained for the set time Ts (detection start section), the control unit 20 determines that the operation is intended by the user, that is, a stop state of the user's finger H, and thereby the process is caused to proceed to Step S2 and a notification process is performed. Specifically, the control unit 20 drives the notification member 21 so as to notify the user of the detection start of the operation.

Next, the control unit 20 causes the process to proceed to Step S3, and determines whether or not the levels of all of the detection signals from 1 ch to 4 ch are temporally changed. Specifically, the control unit 20 determines whether or not the levels of all of the detection signals from 1 ch to 4 ch are maintained for a longer time than the time (Th) taken during the maintaining state in which the angled point is detected. Then, when it is determined that the levels of all of the detection signals from 1 ch to 4 ch are temporally changed, the control unit 20 determines that the user draws a unicursal character or symbol, and repeats the same processes. The control unit 20 causes the process to proceed to Step S4 after determining that the levels of all of the detection signals from 1 ch to 4 ch are not temporally changed, and then determines whether or not the state, in which the levels of the detection signals are not temporally changed, is maintained for a set time Te (for example, several seconds). The set time Te is also set to be sufficiently longer than the time taken during the maintaining state in which the angled point is detected.

Subsequently, the control unit 20 causes the process to proceed to Step S5 after determining that the state, in which the levels of all of the detection signals from 1 ch to 4 ch are not temporally changed, is maintained for the set time Te (for example, several seconds). This is because the duration of the set time Te is considered an operation intended by the user, that is, a stop state of the user's finger H.

The control unit 20 performs the notification process in Step S5. Specifically, the control unit 20 drives the notification member 21 such that the notification member notifies the user of the end of the operation detection (completion of detection).

Next, the control unit 20 causes the process to proceed to Step S6, and determines whether or not the levels of all of the detection signals from 1 ch to 4 ch are lower than a predetermined lower-limit threshold level Le (<Ls). This is for determining whether or not the finger H of the user, to whom the end of the operation detection is notified, is separated from the sensor body 10 (mark 8) in response to the notification. Then, the control unit 20 causes the process to proceed to Step S7 after determining that the levels of all of the detection signals from 1 ch to 4 ch become lower than the lower-limit threshold level Le, and performs character or symbol recognition processing.

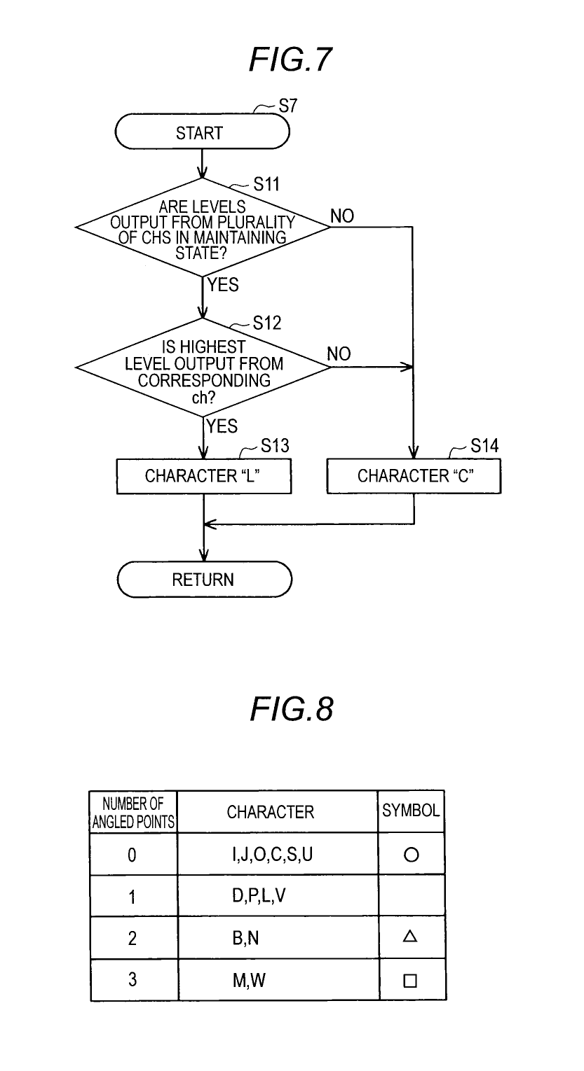

In other words, as illustrated in FIG. 7, in Step S11, the control unit 20 determines whether or not two or more detection signals from 1 ch to 4 ch are simultaneously in the maintaining state. Here, when it is determined that two or more detection signals from 1 ch to 4 ch are simultaneously in the maintaining state, the control unit 20 causes the process to proceed to Step S12, and determines whether or not the level of the detection signal from the corresponding ch disposed at a position at which the angled point of “L” exists, that is, 2 ch (electrode 12), is the highest level (higher than the levels of the detection signals of all the other chs). Then, when the level of the detection signal of the corresponding ch is the highest level, the control unit 20 causes the process to proceed to Step S13 and discriminates “L”.

By comparison, in Step S11, when it is determined that two or more detection signals from 1 ch to 4 ch are not simultaneously in the maintaining state, or, in Step S12, it is determined that the level of the detection signal of the corresponding ch is not the highest level, the control unit 20 causes the process to proceed to Step S14 and discriminates “C”.

As described above, the control unit 20 that has discriminated between “L” and “C” causes the process to proceed to Step S8 in FIG. 6, and performs output processing in response to the discrimination result. Specifically, the control unit 20 that has discriminated “L” in Step S13 outputs, to the door ECU 7, an operation signal indicating that the door lock 5 is subjected to the locking actuation. Otherwise, the control unit 20 that has discriminated “C” in Step S14 outputs, to the door ECU 7, an operation signal indicating that the back door 3 is subjected to the close actuation.

Next, an example of unicursal characters or symbols which can be employed in operation detection by the control unit 20 will be described.

As illustrated in FIG. 8, there are various unicursal characters or symbols which can be employed in operation. For example, in a case where the number of angled points is “0” (without an angled point), there are characters such as I, J, O, C, S, and U, and there is a symbol such as O. In addition, in a case where the number of angled points is “1”, there are characters such as D, P, L, and V. Further, in a case where the number of angled points is “2”, there are characters such as B and N, and there is a symbol such as A. In addition, in a case where the number of angled points is “3”, there are characters such as M and W, and there is a symbol such as In this manner, in addition to the presence of the angled point, the number of the angled points is monitored together by the control unit 20, thereby making it possible to increase the number of types of characters or symbols which the control unit can discriminate between, that is, the number of types of settable operations therewith.

In a case where the characters or symbols have the number of angled points that belongs to the same group, it is not always possible to discriminate between the characters or symbols. Therefore, it is preferable that the most suitable one or a plurality of characters or symbols are selected. In addition, also even in the case where the number of angled points belongs to the same group, the characters or symbols, which are discriminated, may be subjected to limitation depending on the state of the target object, and thereby erroneous detection may be prevented. For example, when “C” and “O” are drawn, the order of the movement of the user's finger H is substantially the same, and both have no angled point. In this case, drawing of “C” and “O” corresponds to, for example, an operation of closing and an operation of opening of the back door 3, respectively. Then, when “C” is accepted only in the opened state of the back door 3, and “O” is accepted only in the closed state, erroneous detection of an operation and an erroneous actuation of the target object in response to the erroneous detection are prevented.

As described above, according to the present embodiment, it is possible to achieve the following effects.

(1) In the present embodiment, for example, when unicursal characters or symbols have similar movement traces of the user's finger H but have different angled points, the control unit 20 can discriminate between the characters or symbols based on the detection results of the angled points. In this manner, as the number of types of characters or symbols which the control unit 20 can discriminate between, it is possible to increase the number of types of settable operations according to the increase. Then, the target object can be subjected to various actuation due to the plurality of types of set operations.

In addition, in order to increase the number of types of settable operations, a complicated electrical configuration (including control) like an X-Y electrode may not be formed, and it is possible to realize space saving or cost saving.

(2) In the present embodiment, the control unit 20 detects the angled point based on that two or more detection signals are simultaneously in the maintaining state. Hence, it is possible to enhance detection accuracy of the angled point by the control unit 20 and therefore, it is possible to enhance discrimination accuracy of the character or symbol by the control unit 20.

(3) In the present embodiment, the control unit 20 detects the angled point, when the detection signal is in the maintaining state and when the level of the detection signal from the electrodes 11 to 14 (the electrode 12 of 2 ch in the case of “L”) disposed at a position at which an angled point of a preset unicursal character or symbol that is drawn by the user's finger H exists, is higher than the levels of the detection signals from all the other electrodes 11 to 14. Hence, it is possible to enhance detection accuracy of the angled point by the control unit 20 and therefore, it is possible to enhance discrimination accuracy of the character or symbol by the control unit 20.

(4) In the present embodiment, according to the stopping of the user's finger H, the control unit 20 detects the start of the operation when the state, in which the level of at least one detection signal from the plurality of electrodes 11 to 14 exceeds the predetermined upper-limit threshold level Ls, is maintained for the set time Ts (start detecting section). In addition, in the detection state of the operation, according to the stopping of the user's finger H, the control unit 20 detects an end of the operation after determining that the state, in which the levels of all of the detection signals from the plurality of electrodes 11 to 14 are not changed, is maintained for the set time Te (end detecting section). Therefore, it is possible to avoid continuing the detection of the operation in vain, and thus it is possible to reduce power consumption, because the control unit 20 may start or end the detection of the operation on the timing of the detection of the start and end of the operation.

(5) In the present embodiment, when the control unit 20 detects the start and the end of the operation, the notification member 21 notifies the user of the detection. Hence, it is possible to check the start and the end of the operation by the control unit 20, due to the notification by the notification member 21, and it is possible to enhance the operability. Then, it is possible to relieve a user's discomfort of, for example, whether the operation is accepted, or it is possible to solve inconvenience of a user who waits in vain for the actuation of the corresponding target object although the operation is not accepted.

(6) In the present embodiment, the electrodes 11 to 14 are disposed to reach the vicinity of the center of the sensor body 10, thereby making it possible to widen a detection region of the electrodes 11 to 14 to the vicinity of the center of the sensor body 10. Therefore, it is possible to basically discriminate both the unicursal character or symbol drawn in the vicinity of the center of the sensor body 10, and the unicursal character or symbol drawn so as to be closer to an outer circumference side.

(7) In the present embodiment, the stopping of the user's finger H related to the detection of the start or end of the operation by the control unit 20 may be performed in the vicinity of the center of the sensor body 10, or may be performed at a position closer to the outer circumference side, in the vicinity of the center of any one of the electrodes 11 to 14, or between any two adjacent electrodes 11 to 14. Hence, it is possible to flexibly cope with variations (tendency) of the operation of the user.

(8) In the present embodiment, the character or symbol related to the detection of the operation is limited to a unicursal character or symbol and thereby, the operation may continue to be detected, as long as the user's finger H is not stopped and the detection signal does not stop being changed, and a computing process by the control unit 20 can be further simplified.

(9) In the present embodiment, the detection can be performed in a state in which the user's finger H does not come into contact with the sensor body by using the change in capacitance obtained by the sensor bodies 10 (electrodes 11 to 14) and the finger H.

(10) In the present embodiment, the control unit 20 monitors the temporal change in all of the detection signals from 1 ch to 4 ch, thereby making it possible to substantially find which ch the user's finger H is positioned over, and then which ch the finger moves toward a position at. Otherwise, the control unit 20 monitors the electrodes 11 to 14 of which the detection signal has the highest level basically, thereby making it possible to substantially find at which ch the user's finger H is positioned.

(11) Normally, since various operation switches of the back door 3 are disposed below the garnish 9, it is difficult to find the position or functions, or it is difficult to operate due to a user's long nails. However, the unicursal characters or symbols may be drawn at the position of the mark 8, thereby making it possible to realize good operability.

Further, the embodiment described above may be altered as follows.

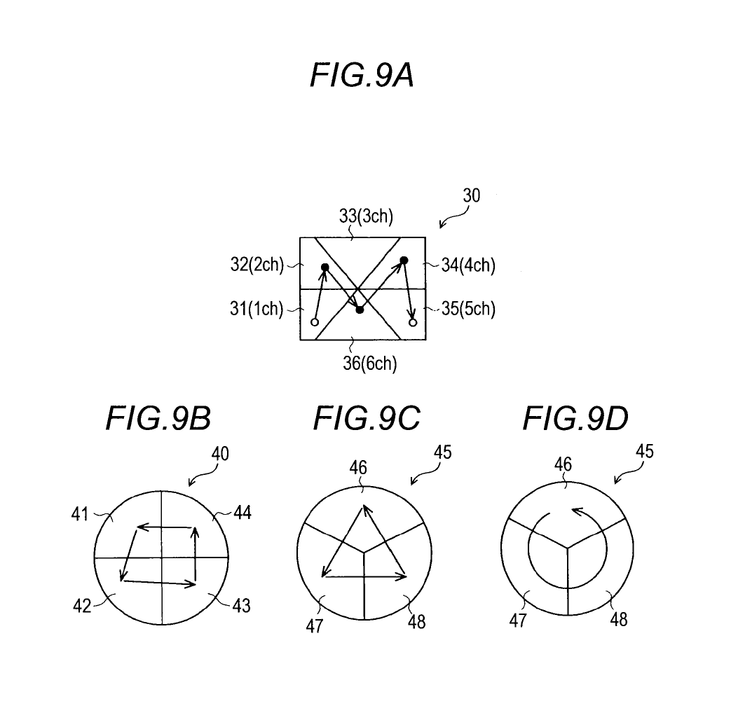

As illustrated in FIG. 9A, a substantially quadrangular sensor body 30 having six radially divided electrodes 31, 32, 33, 34, 35, and 36 may be employed. The electrodes 31 to 36 radially disposed from the vicinity of the center of the sensor body 30 configure 1 ch to 6 ch in this order from the lower left portion in a clockwise direction in FIG. 9A. In FIG. 9A, “M” is drawn as an example of the unicursal character or symbol. Outline circles on the character represent a detection start position or a detection end position of the operation by the control unit 20, and black circles represent positions of angled portions detected by the control unit 20. As is clear in the drawing, in the case of drawing “M”, the detection start position and the detection end position are placed on 1 ch and 5 ch, respectively, and angled portions are positioned on 2 ch, 4 ch, and 6 ch. In this manner, when the sensor body 30 having “six” electrodes is employed, various types of reference data (information) such as a change in chs, on which the angled portion is formed, are utilized, and thereby it is assumed that the number of types of unicursal characters or symbols, which can be discriminated, is sufficiently increased.

In addition, as illustrated in FIG. 9B, a substantially circular sensor body 40 having four radially divided electrodes 41, 42, 43, and 44, which have a substantial fan shape, may be employed. In FIG. 9B, “□” is drawn as an example of the unicursal character or symbol. As is clear in the drawing, in the case of drawing “□”, the angled portions are positioned on all of the electrodes 41 to 44.

Further, as illustrated in FIGS. 9C and 9D, a substantially circular sensor body 45 having three radially divided electrodes 46, 47, and 48, which have a substantial fan shape, may be employed. In the drawings, “Δ” and “ο” are drawn, respectively, as an example of the unicursal character or symbol. As is clear in the drawings, in the case of drawing “Δ”, the angled portions are positioned on all of the electrodes 46 to 48, and in the case of drawing“ο”, the angled portions are not positioned on any of the electrodes 46 to 48.

In this manner, the sensor body has any shape and an arbitrary number of electrodes. However, it is preferable that the sensor body has “six” or fewer electrodes with which the number of types of unicursal characters or symbols, which can be discriminated, can be increased without a complicated electrical configuration. When the plurality of electrodes are radially disposed from the vicinity of the center of the sensor body, it is more effective to discriminate between unicursal characters or symbols.

In the embodiments described above, notification may be performed by the notification member 21 when recognition processing of the character or symbol succeeds (is complete) in Step S7. Similarly, notification may be performed by the notification member 21 when recognition processing of the character or symbol fails (is incomplete) in Step S7. However, it is preferable that notification states of both success and failure cases are different from each other. For example, in both cases, notification patterns by the notification member 21 may be different from each other, or notification members 21, which are used, may be different from each other in a case where a plurality of types of or a plurality of notification members 21 are provided.

In the embodiments described above, the notification (Step S5) by the notification member 21 during the detection of the end of the operation may be performed after the levels of the detection signals from all of 1 ch to 4 ch are lower than the predetermined lower-limit threshold level Le (YES in Step S6).

In the embodiments described above, the notification (Step S2) by the notification member 21 during the detection of the start of the operation may be omitted. Similarly, the notification (Step S5) by the notification member 21 during the detection of the end of the operation may be omitted.

In the embodiments described above, in a state in which the level of the detection signal from any one of 1 ch to 4 ch (electrodes 11 to 14) exceeds the predetermined upper-limit threshold level Ls, detection of the operation by the control unit 20 may be started before the state, in which the levels exceed the upper-limit threshold level Ls, is maintained for the set time Ts. In other words, the process in Step S1 may be omitted. Similarly, in the detection state of the operation, the detection of the operation by the control unit 20 may be ended in a state in which the levels of the detection signals of all of 1 ch to 4 ch are lower than the predetermined lower-limit threshold level Le, before the state, in which the levels of the detection signals of all of 1 ch to 4 ch are not temporally changed, is maintained for the set time Te. In other words, the process in Step S4 may be omitted.

In the embodiments described above, when it is determined that the level of the detection signal of the corresponding ch disposed at a position at which the angled point exists, is not the highest level (NO in Step S12), the control unit 20 may end the process as is without discriminating between the characters or symbols. In this case, it is preferable that the notification member 21 performs notification so as to urge the user to correct the operation.

In the embodiment described above, when two or more detection signals from 1 ch to 4 ch are simultaneously in the maintaining state (YES in Step S11), discrimination of “L” may be performed as is. In other words, the process in Step S12 may be omitted.

In the embodiment described above, instead of the process in Step S11, when the detection signal of any one of 1 ch to 4 ch is in the maintaining state, discrimination of “L” may be performed.

In the embodiment described above, even in the case where it is determined that two or more detection signals from 1 ch to 4 ch are not simultaneously in the maintaining state (NO in Step S11), the control unit 20 may end the process as is without discriminating between the characters or symbols when any one of the detection signals is in the maintaining state. In this case, it is preferable that the notification member 21 performs notification so as to urge the user to correct the operation.

In the embodiment described above, the recognition processing of the character or symbol in Step S7 may be performed with reference to the order of 1 ch to 4 ch on which the peak (crest) of the detection signal appears. Otherwise, the recognition processing may be performed with reference to a ch (particularly, ch from which the detection signal has the highest level at the time of the detection of the start or end of the operation) from which the detection signal has the highest level, of 1 ch to 4 ch. For example, the recognition processing may be performed with reference to whether or not the ch from which the detection signal has the highest level at the time of the detection of the start of the operation is the same as the ch from which the detection signal has the highest level at the time of the end detection of the operation. Since the reference data correlates with the movement trace of the user's finger H, it is possible to enhance recognition accuracy of the character or symbol.

In the embodiment described above, a plurality of characters or symbols may be drawn by the user's finger H for one operation. In this case, operation detection is redundantly performed due to the plurality of characters or symbols and it is possible to reduce erroneous detection due to an effect of inadvertent behavior of the user or a passerby, vehicle washing, rain, snow, or the like, in a case where the operation is performed as an intentional operation (operation intended by the user). Otherwise, in a case where another type of operation is defined by combining the plurality of characters or symbols, it is possible to increase the number of types of settable operations. Further, the plurality of characters or symbols may be combined not to have any meaning (for example, repetition of the same characters or symbols, an ID, a password, or the like), or may be combined to have some meaning (for example, user name, a name of a living organism, or the like).

In the embodiment described above, the “unicursal character or symbol” means a character or symbol which can be unicursally drawn by a straight line, a curve, or a combination thereof, regardless of having the angled portion.

In the embodiment described above, the control unit 20 may directly control the drive of the door drive unit 4 or the door lock drive unit 6 without the door ECU 7.

In the embodiment described above, the detection signal may be monitored by the control unit 20 in an analog processing manner or in a digital processing manner.

In the embodiment described above, functions of the control unit 20 may be realized with a hardware configuration in which, for example, logic circuits are combined.

In the embodiment described above, as long as a position of the sensor body can be recognized, the sensor body may be disposed at any position of the vehicle 1, which the user's body (finger H or the like) reaches. For example, the sensor body may be disposed on a center pillar or a rear pillar adjacent to the back door 3, in steering, on an instrument panel, or the like.

In the embodiment described above, the target object may be a latch mechanism that is disposed in the back door 3 and can be electrically engaged with and disengaged from a striker on the body 2 side. In this case, the back door 3 may be automatically subjected to the opening in response to disengagement actuation of the latch mechanism in a case where, particularly, a torsion spring, a bus damper, or the like, by which the back door 3 is subjected to the opening, is provided.

In the embodiment described above, the target object may be a swing-type or sliding-type side door (a front door, a rear door, or the like), or a trunk lid, which is electrically openable and closable a door lock or a latch mechanism which is disposed in the door or lid, or the like. Otherwise, the target object may be a door mirror or a bonnet, a sunroof, a filler cap, or the like which is electrically openable and closable. Otherwise, the target object may be equipment such as an automatic door or a toilet seat apparatus, a water heater, a power-generating facility, or the like which is disposed in a building or the like.

In the embodiment described above, the operation body may be a body (for example, a foot) other than the finger H of the user. Otherwise, the operation body may be a glove woven with conductive thread, a so-called stylus pen, or the like.

In the embodiment described above, the mark 8 may be an emblem representing a brand, a type, a grade, or the like of vehicle 1. The mark 8 may be arbitrarily formed by a character, graphics, a symbol, a three-dimensional shape, or a combination thereof.

An operation apparatus according to an aspect of this disclosure includes: a plurality of electrodes that configure different channels, respectively, and that output a detection signal having a level depending on a location of an operation body which is in contact or is not in contact therewith; and an operation detecting unit that detects an operation on a target object based on the detection signal from the plurality of electrodes. The operation detecting unit includes an angled-point detecting section that detects an angled point of a unicursal character or symbol that is drawn by the operation body, based on that the detection signal is in a maintaining state of maintaining a constant level, and a discrimination section that discriminates a unicursal character or symbol that is drawn by the operation body, based on the detection result of the angled point by the angled-point detecting section.

In this configuration, when the unicursal characters or symbols are drawn by similar movement traces of the operation body, but have different angled points, respectively, the discrimination section can discriminate the characters or symbols based on the detection results of the angled point by the angled-point detecting section. In this manner, it is possible to increase the number of types of settable operations by an increase in the number of types of characters or symbols that can be discriminated by the discrimination section.

In the operation apparatus, it is preferable that the angled-point detecting section detects the angled point in a case where the two or more detection signals are simultaneously in the maintaining states.

In this configuration, it is possible to enhance detection accuracy of the angled point by the angled-point detecting section and therefore, it is possible to enhance discrimination accuracy of the character or symbol by the discrimination section.

In the operation apparatus, it is preferable that the angled-point detecting section detects the angled point, when the detection signal is in the maintaining state and when the level of the detection signal from the electrodes disposed at a position, at which an angled point of a preset unicursal character or symbol that is drawn by the operation body exists, is higher than the levels of the detection signals from all the other electrodes.

In this configuration, it is possible to enhance detection accuracy of the angled point by the angled-point detecting section and therefore, it is possible to enhance discrimination accuracy of the character or symbol by the discrimination section.

In the operation apparatus, it is preferable that the angled-point detecting section detects the angled point, when the two or more detection signals are simultaneously in the maintaining states and when the level of the detection signal from the electrode disposed at a position, at which an angled point of a preset unicursal character or symbol that is drawn by the operation body exists, is higher than the levels of the detection signals from all the other electrodes

In the operation apparatus, it is preferable that the operation detecting unit includes at least one of a start detecting section that detects a start of the operation based on that a state, in which the level of at least one of the detection signals from the plurality of electrodes exceeds an upper limit threshold level, is maintained for a longer time than the maintaining state in which the angled point is detected, or an end detecting section that, in the detection state of the operation, detects an end of the operation based on that a state, in which the levels of all the detection signals from the plurality of electrodes are not changed, is maintained for a longer time than the maintaining state in which the angled point is detected.

In this configuration, the operation detecting unit may start or end the detection of the operation on at least one timing of detection of a start of the operation by the start detecting section or detection of an end of the operation by the end detecting section. Therefore, it is possible to avoid continuing the detection of the operation in vain, and thus it is possible to reduce power consumption.

It is preferable that the operation apparatus further includes a notification member that notifies at least one of the start of the operation detected by the start detecting section or the end of the operation detected by the end detecting section when the detection thereof is performed.

In this configuration, the user can recognize the start or the end of the detection of the operation by the operation detecting section through the notification by the notification member, and it is possible to enhance operability.

This disclosure has an effect that it is possible to increase the number of types of sellable operations.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An operation apparatus comprising:
a plurality of electrodes that configure different channels, respectively, and that output a detection signal having a level depending on a location of an operation body which is in contact or is not in contact therewith; and
an operation detecting unit that detects an operation on a target object based on the detection signal from the plurality of electrodes,
wherein the operation detecting unit includes
an angled-point detecting section that detects an angled point of a unicursal character or symbol that is drawn by the operation body, based on that the detection signal is in a maintaining state of maintaining a constant level, and
a discrimination section that discriminates a unicursal character or symbol that is drawn by the operation body, based on the detection result of the angled point by the angled-point detecting section.

2. The operation apparatus according to claim 1,
wherein the angled-point detecting section detects the angled point in a case where the two or more detection signals are simultaneously in the maintaining states.

3. The operation apparatus according to claim 1,
wherein the angled-point detecting section detects the angled point, when the detection signal is in the maintaining state and when the level of the detection signal from the electrodes disposed at a position, at which an angled point of a preset unicursal character or symbol that is drawn by the operation body exists, is higher than the levels of the detection signals from all the other electrodes.

4. The operation apparatus according to claim 1,
wherein the angled-point detecting section detects the angled point, when the two or more detection signals are simultaneously in the maintaining states and when the level of the detection signal from the electrode disposed at a position, at which an angled point of a preset unicursal character or symbol that is drawn by the operation body exists, is higher than the levels of the detection signals from all the other electrodes.

5. The operation apparatus according to claim 1,
wherein the operation detecting unit includes at least one of
a start detecting section that detects a start of the operation based on that a state, in which the level of at least one of the detection signals from the plurality of electrodes exceeds an upper limit threshold level, is maintained for a longer time than the maintaining state in which the angled point is detected, or
an end detecting section that, in the detection state of the operation, detects an end of the operation based on that a state, in which the levels of all the detection signals from the plurality of electrodes are not changed, is maintained for a longer time than the maintaining state in which the angled point is detected.

6. The operation apparatus according to claim 5, further comprising:
a notification member that notifies at least one of the start of the operation detected by the start detecting section or the end of the operation detected by the end detecting section when the detection thereof is performed.
